(19) United States
(12) Patent Application Publication
(10) Pub. No.: US 2023/0153929 A1
(43) Pub. Date: May 18, 2023

(54) SERVICE CONSTRUCTION SUPPORTING METHOD

(71) Applicant: NEC Corporation, Tokyo (JP)

(72) Inventor: Katsuhiko ISHIDA, Tokyo (JP)

(73) Assignee: NEC Corporation, Tokyo (JP)

(21) Appl. No.: 17/982,825

(22) Filed: Nov. 8, 2022

(30) Foreign Application Priority Data
Nov. 18, 2021 (JP) 2021-187814

(51) Int. Cl. G06Q 50/10

(52) U.S. Cl. CPC G06Q 50/10

(57) ABSTRACT

A service construction supporting device 100 of the present invention is a device that supports construction of a service using a plurality of resources, provided by specific business operators, in combination with each other. The device includes an acquisition unit 121 that acquires resource information representing information related to the resources to be used in the service, an examination unit 122 that examines the feasibility of the service on the basis of the resource information of each of the resources to be used in the service, and a registration unit 123 that registers the service so as to allow the resources to be used in the service, determined to be feasible, to be provided in combination with each other.

### INCORPORATION BY REFERENCE

The present invention is based upon and claims the benefit of priority from Japanese patent application No. 2021-187814, filed on Nov. 18, 2021, the disclosure of which is incorporated herein in its entirety by reference.

### TECHNICAL FIELD

The present invention relates to a service construction supporting method, a service construction supporting device, and a program.

### BACKGROUND ART

Along with development in the information and communication technology (ICT), digital services provided in the Internet environment (web environment) are increasing. To provide such services, resources such as facilities, devices, software, and data are required. When providing such a service, it is not always necessary to prepare all resources by own, but it is possible to use them while being supplied from other business operators. In the case where resources are supplied from other business operators, it is necessary to examine whether the resources are actually usable in the environment where the service is provided. For example, Patent Literature 1 describes that a module that is a resource to be supplied is tested as to whether it is operable on a desired device.

Patent Literature 1: JP 2002-318828 A

However, in the case of providing a service using a plurality of different types of resources by combining them, the service provider needs to find desired resources from other business operators, which causes labor. In addition, the service provider needs to examine whether each resource can be used in the service in advance. This causes a problem that it is difficult to promptly provide a service using a plurality of resources in combination with each other.

### SUMMARY

In view of the above, an exemplary object of the present invention is to provide a service construction supporting method capable of solving the above-described problem, that is, it is difficult to promptly provide a service using a plurality of resources in combination with each other.

A service construction supporting method, according to one exemplary aspect of the present invention, is a method for supporting construction of a service using a plurality of resources, provided by specific business operators, in combination with each other. The method is configured to include

acquiring resource information representing information related to the plurality of resources to be used in the service,

on the basis of the resource information of each of the resources to be used in the service, examining the feasibility of the service, and

registering the service so as to allow the resources to be used in the service, determined to be feasible, to be provided in combination with each other.

A service construction supporting device, according to one exemplary aspect of the present invention, is a device for supporting construction of a service using a plurality of resources, provided by specific business operators, in combination with each other. The device is configured to include

an acquisition unit that acquires resource information representing information related to the plurality of resources to be used in the service,

an examination unit that, on the basis of the resource information of each of the resources to be used in the service, examines the feasibility of the service, and

a registration unit that registers the service so as to allow the resources to be used in the service, determined to be feasible, to be provided in combination with each other.

A program, according to one exemplary aspect of the present invention, is configured to cause an information processing device that supports construction of a service using a plurality of resources in combination with each other, to execute processing to

acquire resource information representing information related to the plurality of resources to be used in the service,

on the basis of the resource information of each of the resources to be used in the service, examine the feasibility of the service, and

register the service so as to allow the resources to be used in the service, determined to be feasible, to be provided in combination with each other.

With the configurations described above, the present invention is capable of promptly providing a service using a plurality of resources in combination with each other.

### BRIEF DESCRIPTION OF DRAWINGS

FIG. 1 is a block diagram illustrating a configuration of a service construction supporting device according to a first exemplary embodiment of the present invention;

FIG. 2 illustrates an example of resource information registered with the service construction supporting device disclosed in FIG. 1;

FIG. 3 is a sequence chart illustrating an operation of the service construction supporting device disclosed in FIG. 1;

FIG. 4 is a sequence chart illustrating an operation of the service construction supporting device disclosed in FIG. 1;

FIG. 5 is a block diagram illustrating a hardware configuration of a service construction supporting device according to a second exemplary embodiment of the present invention;

FIG. 6 is a block diagram illustrating a configuration of the service construction supporting device according to the second exemplary embodiment of the present invention; and

FIG. 7 is a flowchart illustrating an operation of the service construction supporting device according to the second exemplary embodiment of the present invention.

### EXEMPLARY EMBODIMENTS

### First Exemplary Embodiment

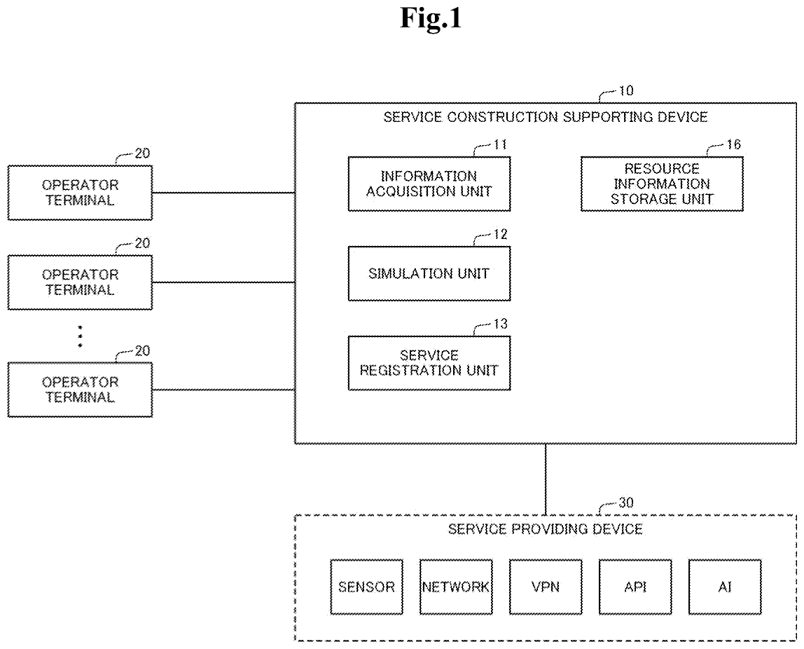

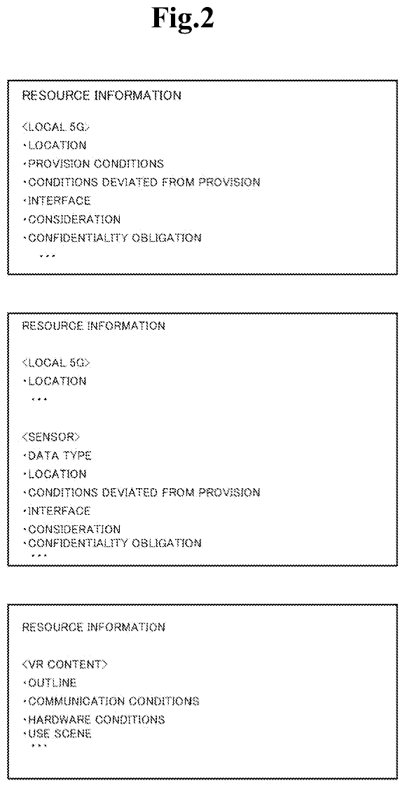

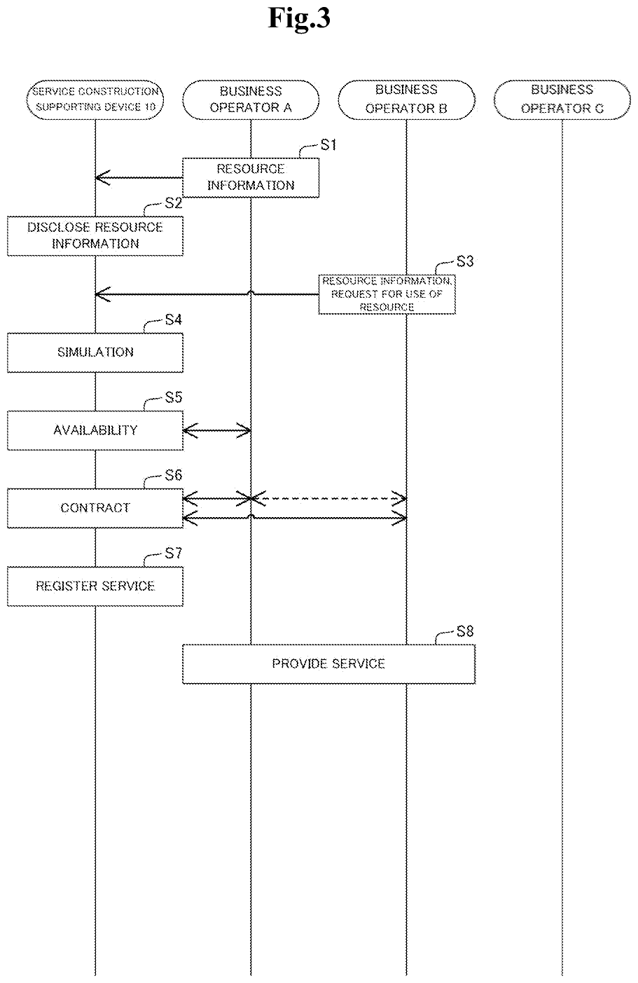

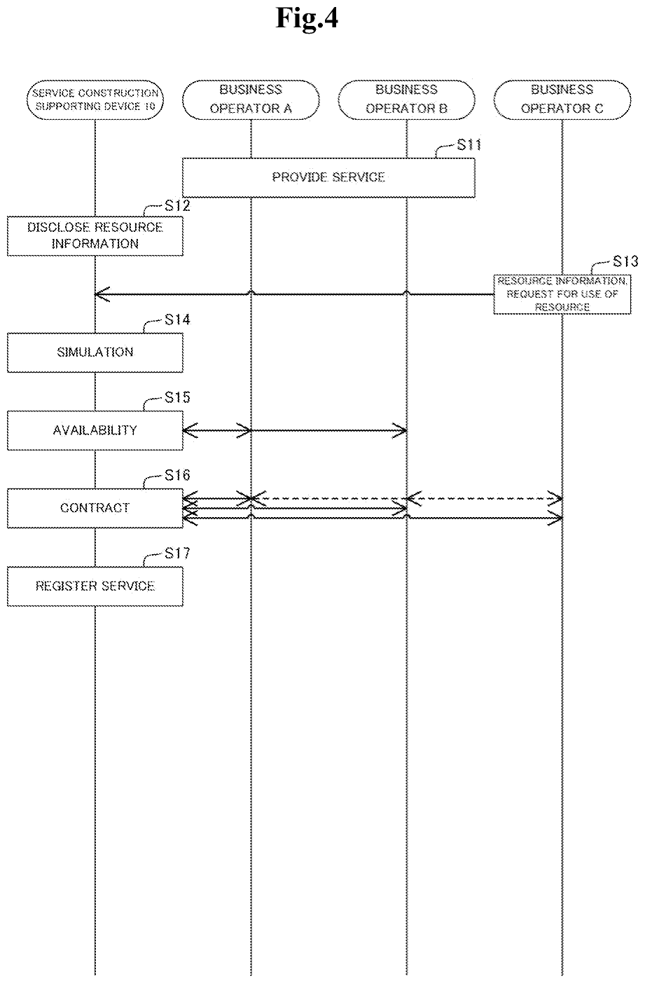

A first exemplary embodiment of the present invention will be described with reference to FIGS. 1 to 5. FIGS. 1 and 2 are diagrams for explaining a configuration of a service construction supporting device, and FIGS. 3 and 4 are diagrams for explaining the processing operation of the service construction supporting device.

### [Configuration]

A service construction supporting device 10 of the present invention is used for supporting construction of a service in which a plurality of resources are combined. For example, the resources include communication networks (5G, 4G, 3G, etc.) provided by specific business operators, sensors (heat sensor, NOx sensor, SOx sensor, CO2 sensor, Geiger counter, etc.), power generators (solar power generator for home use, fuel cell for home use, for industrial use, etc.), capacitors (for each capacity, for each power type, for each CO2 emissions), data collection platforms (data selling APIs), analysis platforms (correlation analysis engine, biometric authentication engine, etc.), visualization platforms (GIS, etc.), control platforms (remote ON/OFF function, etc.), software, digital contents, facilities, installations, and the like. Moreover, the services combining these resources include services provided in the Internet environment and services provided in daily life. As examples, such services may include a management system providing service constructed by combining a network line, sensors, and digital contents as resources, a vehicle charging service constructed by combining power generation facilities, power supply facilities, and an electric vehicle data collection system as resources, and the like. However, resources and services are not limited to those described above, and any resources and services may be used.

The service construction supporting device 10 is mainly constructed by a web server installed on the Internet. The service construction supporting device 10 is connected to an operator terminal 20 operated by a business operator providing a resource over a network, and discloses, to the operator terminal 20, information related to a resource provided by another business operator. The service construction supporting device 10 has a function of supporting exchanges between a plurality of business operators so as to smoothly proceed construction of a service combining resources provided by a plurality of business operators, in response to a request from the operator terminal 20.

Specifically, the service construction supporting device 10 is configured of one or a plurality of information processing devices each having an arithmetic unit and a storage unit. As illustrated in FIG. 1, the service construction supporting device 10 includes an information acquisition unit 11, a simulation unit 12, and a service registration unit 13. The functions of the information acquisition unit 11, the simulation unit 12, and the service registration unit 13 can be realized through execution, by the arithmetic unit, of a program for realizing the respective functions stored in the storage device. The service construction supporting device 10 also includes a resource information storage unit 16. The resource information storage unit 16 is configured of a storage device. Hereinafter, the respective constituent elements will be described in detail.

The information acquisition unit 11 (acquisition unit) acquires resource information representing information related to a resource, from the operator terminal 20 of a business operator who provides a resource, and stores it in the resource information storage unit 16. Then, the information acquisition unit 11 discloses resource information registered by each business operator, to the operator terminal 20 of another business operator. In the resource information, format is set for each resource type. For example, the resource information is configured of information such as resource installation location, resource provision conditions, conditions deviated from the scope of provision, resource interface, consideration for providing a resource, presence or absence of confidentiality obligation, outline and sample of resource itself, conditions on facilities and hardware in which the resource is used, use scene of the resource, and the like.

Here, description will be given by using business operators A, B, and C as exemplary business operators who provide resources in the present embodiment. The business operator A is a business operator who installs and provides a local 5G communication network. In this case, the resource information registered by the business operator A includes, as illustrated in the upper drawing of FIG. 2, information items that are set corresponding to the resource “local 5G communication network” such as “Location: geographical information covered by an antenna of local 5G (or antenna installation location”, “Provision conditions: bandwidth, period of time, when disaster”, “Conditions deviated from scope of provision: inspection schedule (date/time separately), when disaster”, “Interface: local 5G standard name”, “Consideration: monthly charge”, and “Confidentiality obligation: none”. The business operator B is a wine manufacturer, and is a business operator who installs a local 5G communication network by the own and also installs a weather related sensor group. In this case, the resource information registered by the business operator B includes, in addition to the information related to the resource “local 5G” as described above, information items set to the resource “weather related sensor group” such as “Data type: illuminance, rainfall amount, temperature, humidity, for each 5 minutes”, “Location: sensor installation location”, “Conditions deviated from scope of provision: inspection schedule (date/time separately), when disaster”, “Interface: distinguish among whether direct IP access to sensor is possible, via carrier 5G, or via local 5G of business operator B”, and “Confidentiality obligation: none”, as illustrated in the intermediate state of FIG. 2. The business operator C is an agriculture related consultant, and is a business operator who provides VR content related to quality management of grapes. In this case, the resource information registered by the business operator C includes information items set to the resource “VR content” such as “Outline: outline of VR content, sample”, “Communication conditions: network band”, “Hardware conditions (necessity of head mount display, propriety of smartphone, etc.)”, and “Use scenes: grape caring method corresponding to weather information, association with academic research such as biodiversity research in a specific area”, as illustrated in the lower drawing of FIG. 2.

The resource information may include resource management information as information for controlling and managing the resource itself. The resource management information may include, when the resource is a communication network, a sensor, or a content as described above, information for controlling operation of the communication network, the sensor, or the content itself by accessing a server that controls it, information for enabling a business operator, to which the resources are provided, to use them, and the like. For example, as illustrated in FIG. 1, when the resource itself is implemented on a service providing device 30 on the network, operation of the resource is controlled on the service providing device 30, or the service itself on the service providing device 30 is provided to another business operator and controlled to be usable.

The information acquisition unit 11 also receives, from the operator terminal 20 of a business operator who found resource information of another business operator registered and disclosed as described above, a construction request for a service combining the resource provided by the business operator and the resource of another registered business operator. For example, in a situation where the resource information of the business operator A has been registered and disclosed, when the business operator B finds the resource information of the business operator A and the business operator B requests construction of a service combining the own resource and the resource of the business operator A, the information acquisition unit 11 acquires information of the service content and the construction request from the operator terminal 20 of the business operator B. In that case, an example is that the business operator B requests construction of a service of performing measurement by the “weather related sensor group” that is a resource of the business operator B with use of the resource of the business operator A, that is, “local 5G”. In this case, the service construction request includes information (condition information) representing the provision conditions of the service, and the information acquisition unit 11 also acquires such information. For example, information representing the service provision conditions include the place, time, and price for providing the service. Note that the information acquisition unit 11 may acquire resource information of the business operator B from the operator terminal 20 of the business operator B along with the service construction request, or acquire it in advance.

The simulation unit 12 (examination unit) examines, on the basis of resource information for each of the resources to be used for the service of the construction request acquired as described above, the feasibility of the service. For example, in the above case, on the basis of the resource information of the resource of the business operator A and the resource information of the resource of the business operator B, the feasibility of a service combining the resource of the business operator A and the resource of the business operator B is examined. As an example, the simulation unit 12 examines the feasibility of the service by examining whether the “location”, “provision conditions”, “interface” and the like of the resource “local 5G” of the business operator included in the resource information as illustrated in FIG. 2 conforms to the “location”, “interface”, and the like of the resource “sensor group” of the business operator B. In addition, the simulation unit 12 examines the feasibility of the service by examining whether each resource satisfies the location, time, price, and the like that are service provision conditions included in the service construction request.

Note that the simulation unit 12 may examine the feasibility of the service by actually controlling the resources to operate the resources to be used for the service by combining them and simulate the operation corresponding to the content of the service. In that case, the simulation unit 12 simulates the processing operation while combining a plurality of resources corresponding to the content of the service by controlling the operation of each resource implemented on the service providing device 30 as illustrated in FIG. 1, and when the simulation succeeds, the simulation unit 12 may determine that the service is feasible. For example, the simulation unit 12 may simulate measurement using the resource “sensors” of the business operator B that is actually installed and collection of the measurement values by using the resource “local 5G” of the business operator A implemented on the service providing device 30, and when it is operable, the simulation unit 12 may determine the feasibility of the service.

The service registration unit 13 (registration unit) registers the service with the resource information storage unit 16 in such a manner that the resources to be used in the service determined to be feasible can be provided in combination. Then, the service registration unit 13 discloses the service in which the registered resources are combined, to another business operator. That is, in the above-described example, the service registration unit 13 registers and discloses “measurement service” using the “local 5G” that is a resource of the business operator A and the “weather related sensor group” that is a resource of the business operator B, as a service that can be provided. At that time, the service registration unit 13 may inquire a business operator providing a resource in which a service construction is requested of whether or not to allow the use of the resource, and register the service only when it is allowed. In that case, a notice is given to the operator terminal 20 of the business operator A that a construction request for a service using the resource of the business operator A is given by the business operator B and, in response to the notice, when the service construction using the resource is allowed by the business operator A, the service is registered.

The service registration unit 13 also performs a contract process for the use between the business operators providing the respective resources to be used in the service. For example, the service registration unit 13 transmits, to the operator terminal 20 of the business operator A and the operator terminal 20 of the business operator B, the fact that the mutual use of the resources is allowed and the information corresponding to the contract describing the conditions for use, and obtains agreement on the contract with the signature or the like from each operator terminal 20. Then, the service registration unit 13 stores the contract information in the resource information storage unit 16 in association with the resource information of the resources used in the service.

Further, the service registration unit 13 may perform provisioning by actually controlling the resource itself and allowing the business operator to use the resource to be used in the service. For example, the service registration unit 13 controls operation of each resource implemented on the service providing device 30 as illustrated in FIG. 1 to perform control such that the resource to be used in the service can be used by the counterpart business operator. In the above-described example, control is made to allow the resource “local 5G” of the business operator A to be usable by the business operator B.

Here, the information acquisition unit 11 described above will be further explained. When the service in which the resources are combined as described above has been registered and disclosed, the information acquisition unit 11 receives a construction request for a new service in which a new resource is further combined to such a service. For example, in the situation where the service “measurement service” using the resource “local 5G” of the business operator A and the resource “weather related sensor group” of the business operator B is registered, when a business operator C finds the resource information of each resource included in the service and requests construction of a new service by further combining the own resource, the information acquisition unit 11 acquires the content of the service and a construction request from the business operator terminal 20 of the business operator C. In that case, as an example, the business operator C requests construction of a service providing “farm product quality management VR content” using the measurement result of the “measurement service” using the resources of the business operator A and the business operator B. In this case, the service construction request includes information representing the provision conditions of the service, and the information acquisition unit 11 also acquires such information. For example, information representing the service provision conditions include the place, time, and price for providing the service. Note that the information acquisition unit 11 may acquire resource information of the business operator C from the operator terminal 20 of the business operator C along with the service construction request, or acquire it in advance.

Then, the simulation unit 12 examines the feasibility of the new service that the business operator C requests to construct, on the basis of the resource information of each resource of the business operators A and B used in the existing service and the resource information of the resource of the business operator C to be newly added. For example, in the above-described case, the simulation unit 12 determines the feasibility of the new service by examining whether the specifications and the use conditions included in the resource information of the respective resources of the business operators A, B, and C are satisfied mutually, or examining whether the provision conditions included in the construction request for the new service are satisfied. Further, the simulation unit 12 may determine the feasibility of the service by actually controlling operation of each resource and simulating the processing operation corresponding to the service content in which the resources to be used in the service are combined.

Further, the service registration unit 13 registers the service in such a manner that the resources used in the new service determined to be feasible can be provided in combination, and discloses it to another business operator. That is, in the above-described example, the service registration unit 13 registers and discloses a new service using the “local 5G” that is a resource of the business operator A, the “weather related sensor group” that is a resource of the business operator B, and the “VR content” that is a resource of the business operator C, as a service that can be provided. At that time, the service registration unit 13 may inquire a business operator providing a resource in which a service construction is requested, of whether or not to allow use of the resource, and register the service only when it is allowed. In the above-described case, a notice is given to the operator terminal 20 of the business operator A and the operator terminal 20 of the business operator B that a construction request for a new service using the resources of the business operators A and B is made by the business operator C, and when the service construction using the respective resources is allowed by the business operators A and B with respect to the notice, the service is registered. That is, when the use is not allowed by any of the business operator A and the business operator B whose resources are desired to be used by the business operator C, a new service is not registered.

Further, as similar to the above description, the service registration unit 13 also performs a contract process for the use among the business operators providing the respective resources to be used in the service. At that time, the service registration unit 13 performs a contract process among the business operators providing the resources respectively. In the above-described case, while the business operator C requests to construct a service with the business operator A and the business operator B, a contract process is performed one to one between the business operators such as between the business operator C and the business operator A, and between the business operator C and the business operator B.

### [Operation]

Next, operation of the service construction supporting device 10 as described above will be described with mainly reference to the flowcharts of FIGS. 3 and 4. First, description will be given on the case of constructing a service using a resource of the business operator A and a resource of the business operator B, with reference to the sequence chart of FIG. 3.

First, the operator terminal 20 of the business operator A transmits resource information of a resource of the business operator A to the service construction supporting device 10 (step S1). The service construction supporting device 10 acquires the resource information of the resource of the business operator A and stores it in the resource information storage unit 16, and discloses the resource information to the operator terminal 20 of another business operator (step S2). For example, the resource of the business operator A is “local 5G communication network”, and the resource information as shown on the upper drawing of FIG. 2 is registered and disclosed. At that time, the resource itself of the business operator A may be implemented on the service providing device 30 and set so as to be controllable by the service construction supporting device 10.

An example will be given on the case where the business operator B finds the disclosed resource information of the resource of the business operator A, and requests construction of a service while combining the own resource and the resource of the business operator A. The operator terminal 20 of the business operator B transmits, to the service construction supporting device 10, resource information of the resource provided by the business operator B, and also a construction request for a service in which the own resource and the resource of the business operator A are combined (step S3). For example, the resources of the business operator B are “local 5G communication network” and “weather related sensor group”, and the business operator B transmits the resource information as illustrated in the intermediate drawing of FIG. 2, and also transmits that the business operator B requests construction of a service of measuring the weather information by using the “weather related sensor group” that is a resource of the business operator B using the “local 5G” that is a resource of the business operator A. At that time, the service construction request may include service provision conditions (for example, location, time, and price). Note that the resource information of the resource of the business operator B may be transmitted to and registered with the service construction supporting device 10 in advance. Further, the resource itself of the business operator B may be implemented on the service providing device 30 and set to be controllable by the service construction supporting device 10.

Then, in response to the service construction request from the business operator B, the service construction supporting device 10 examines the feasibility of the service using the resources in combination, on the basis of the resource information of the resources to be used in the service (step S4). In that case, the service construction supporting device 10 examines the feasibility of the service by examining whether the specifications and the use conditions included in the resource information of the resource “local 5G” of the business operator A and the specifications and the use conditions included in the resource information of the resource “weather related sensor group” of the business operator B conform to each other, and whether the resource information satisfies the service provision conditions included in the service construction request, as illustrated in FIG. 2. Note that the service construction supporting device 10 may examine the feasibility of the service by actually controlling the resource of the business operator A and the resource of the business operator B and simulating the processing operation corresponding to the content of the service by combining them.

When determining that the service is feasible, the service construction supporting device 10 inquires the business operator A that is a counterpart of the service construction request given by the business operator B, of the use permission of the resource of the business operator A (step S5). When acquiring use permission of the resource from the business operator A, the service construction supporting device 10 performs a contract process between the business operator A who is the party providing the resource and the business operator B (step S6). At that time, the service construction supporting device 10 transmits information equivalent to a contract to the operator terminal 20 of the business operator A and the operator terminal 20 of the business operator B, and obtains mutual agreement such as signatures. As a result, as illustrated by an arrow of a dotted line in FIG. 3, a contract of mutual use of resources between the business operator A and the business operator B is completed.

Then, the service construction supporting device 10 registers and discloses the service in which the resource of the business operator A and the resource of the business operator B are combined. As a result, the service is provided to the general users by the business operator B, and is also available to other business operators as described below.

Next, description will be given on the case of constructing a service using a resource of the business operator A, a resource of the business operator B, and a resource of the business operator C, with reference to the sequence chart of FIG. 4.

First, it is assumed that the service in which the resource of the business operator A and the resource of the business operator B are combined has been provided by the business operator A and the business operator B as described above (S11), and is disclosed by the service construction supporting device 10 (step S12). An example will be given that in such a situation, the business operator C finds the disclosed service content, and requests construction of a new service by further combining the own resource of the business operator C to such a service. The operator terminal 20 of the business operator C transmits, to the service construction supporting device 10, resource information of the resource provided by the business operator C, and also a service construction request to combine the own resource and the resources of the business operators A and B (step S13). For example, the resource of the business operator C is “farm product quality management VR content”. The business operator C transmits the resource information as illustrated in the lower drawing of FIG. 2, and transmits a construction request for a new service “quality management of farm products corresponding to weather information” by combining the “weather information measurement service” using the resources of the business operator A and the business operator B and the “VR content” that is the resource of the business operator C. At that time, the service construction request may include service provision conditions (for example, location, time, and price). Note that the resource information of the resource of the business operator C may be transmitted to and registered with the service construction supporting device 10 in advance. Further, the resource itself of the business operator C may be implemented on the service providing device 30 and set to be controllable by the service construction supporting device 10.

Then, in response to the service construction request from the business operator C, the service construction supporting device 10 examines the feasibility of the service by combining the resources, on the basis of the resource information of the resources to be used in the service (step S14). In that case, the service construction supporting device 10 examines the feasibility of the service by examining whether the specifications and the use conditions included in the resource information of the resource “local 5G” of the business operator A, the specifications and the use conditions included in the resource information of the resource “weather related sensor group” of the business operator B, and the specifications and the use conditions included in the resource information of the resource “VR content” of the business operator C, as illustrated in FIG. 2, conform to one another and whether the resource information satisfies the service provision conditions included in the service construction request. Note that the service construction supporting device 10 may check the feasibility of the service by actually controlling the resource of the business operator A, the resources of the business operator B, and the resource of the business operator C to simulate the processing operation corresponding to the content of the service by combining them.

When determining that the service is feasible, the service construction supporting device 10 inquires the business operator A and the business operator B who are counterparts of the service construction request by the business operator C, of the use permission of the respective resources of the business operators A and B (step S15). When obtaining use permission of the respective resources from the business operator A and the business operator B, the service construction supporting device 10 performs a contract process between the business operator A who is the party providing the resource and the business operator B, and between the business operator A and the business operator C (step S16). At that time, the service construction supporting device 10 transmits information equivalent to a contract to the operator terminal 20 of the business operator A, the operator terminal 20 of the business operator B, and the operator terminal 20 of the business operator C, and obtains mutual agreement such as signatures. As a result, as illustrated by an arrow of a dotted line in FIG. 4, a contract of mutual use of the resources between the business operator A and the business operator B and between the business operator A and the business operator C, respectively, is completed.

Then, the service construction supporting device 10 registers and discloses the service in which the resource of the business operator A, the resource of the business operator B, and the resource of the business operator C are combined. As a result, the service is provided to the general users by the business operator C, and is also available to other business operators as described below.

As described above, in the present embodiment, it is possible to examine the feasibility of a service in which a plurality of resources are combined, and register the service. Therefore, for a service provider, the labor for constructing a service using a resource provided by another business operator can be suppressed, and such a service can be provided quickly.

### Other Examples

Next, other examples of business operators who provide resources and a service to be constructed will be described by using business operators D, E, and F. The business operator D provides a resource “electric vehicle charging”, and the business operator E provides a resource “regenerated energy power generation”. It is assumed that the business operator D and the business operator E determined to provide a service by combining the resources mutually, and that such a service is registered with the service construction supporting device 10. The service is to charge an electric vehicle with electric power made of regenerated energy that the business operator D purchased from the business operator E, from a charger (charging station) provided by the business operator D. In that case, when a charger of the business operator D is used for charging an electric vehicle, it is possible to provide Tradable Green Certificates, so that it is advantageous for both of them.

Description will be given on an example that the business operator F considers to construct a new service by participating in the electric vehicle charging service as described above. The business operator F is an automobile manufacturer, and manufactures electric vehicles and also provides a resource “information providing system providing location information and remaining charged amount of electric vehicles”. In this case, the business operator F requests construction of a new service of charging electric power by the regenerated energy of the business operator E from a charging station of the business operator D on the basis of the location information of an electric vehicle manufactured by the business operator F, while combining the own resource “information providing system,” the resource “electric vehicle charging” of the business operator D, and the resource “regenerated energy power generation” of the business operator E.

Then, when it is determined that the service is feasible on the basis of the resource information of each resource by the service construction supporting device 10 as similar to the description provided above, the new service requested by the business operator F is registered. As a result, first, the business operator F can promote provision of location information and remaining charged amount of electric vehicles manufactured by itself, and to promote sales of electric vehicles. Moreover, the business operator D can call electric vehicles of the business operator F in the own charging station, and the business operator E can supply electric power at the charging station of the business operator D when there is surplus regenerated energy power.

### Second Exemplary Embodiment

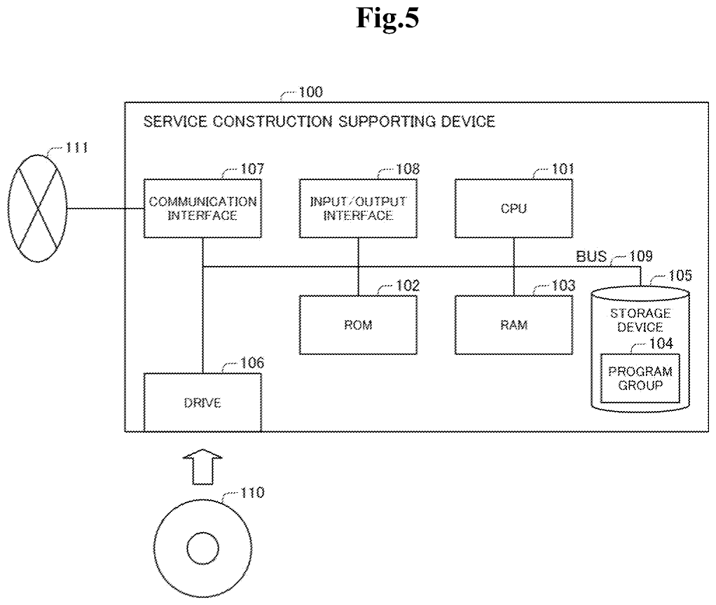

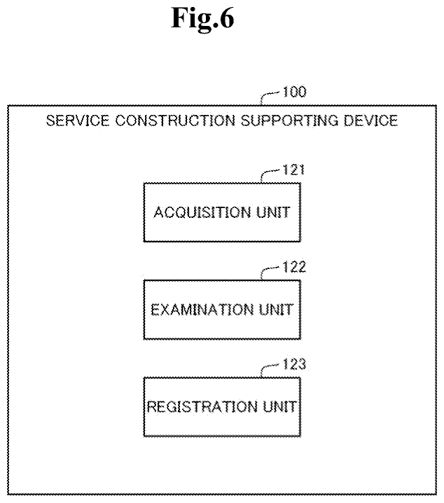

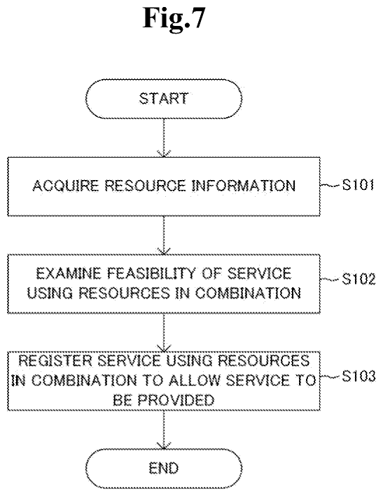

Next, a second exemplary embodiment of the present invention will be described with reference to FIGS. 5 to 7. FIGS. 5 and 6 are block diagrams illustrating a configuration of a service construction supporting device of the second exemplary embodiment, and FIG. 7 is a flowchart illustrating an operation of the service construction supporting device. Note that the present embodiment shows the outlines of the configurations of the service construction supporting device and the service construction supporting method described in the above-described embodiment.

First, a hardware configuration of a service construction supporting device 100 in the present embodiment will be described with reference to FIG. 5. The service construction supporting device 100 is configured of a typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the constituent elements

The service construction supporting device 100 can construct, and can be equipped with, an acquisition unit 121, an examination unit 122, and a registration unit 123 illustrated in FIG. 6 through acquisition and execution of the program group 104 by the CPU 101. Note that the program group 104 is stored in the storage device 105 or the ROM 102 in advance for example, and is loaded to the RAM 103 and executed by the CPU 101 as needed. Alternatively, the program group 104 may be provided to the CPU 101 via the communication network 111, or may be stored on the storage medium 110 in advance and read out by the drive 106 and supplied to the CPU 101. However, the acquisition unit 121, the examination unit 122, and the registration unit 123 may be constructed by dedicated electronic circuits for implementing such means.

Note that FIG. 5 illustrates an example of the hardware configuration of the information processing device that is the service construction supporting device 100. The hardware configuration of the information processing device is not limited to that described above. For example, the information processing device may be configured of part of the configuration described above, such as without the drive 106.

The service construction supporting device 100 executes the service construction supporting method illustrated in the flowchart of FIG. 7, by the functions of the acquisition unit 121, the examination unit 122, and the registration unit 123 constructed by the program as described above.

As illustrated in FIG. 7, the service construction supporting device that supports construction of a service using a plurality of resources provided by specific business operators in combination with each other, executes processing to

acquire resource information representing information related to a plurality of resources to be used in the service (step S101),

on the basis of the resource information of each of the resources to be used in the service, examining the feasibility of the service (step S102), and

registering the service such that the resources to be used in the service determined to be feasible can be provided in combination with each other (step S103).

Since the present invention is configured as described above, the present invention can examine the feasibility of a service in which a plurality of resources are combined, and register the service. Therefore, for a service provider, the labor for constructing a service using a resource provided by another business operator can be suppressed, and such a service can be provided promptly.

Note that the program described above can be supplied to a computer by being stored in a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), a flash ROM, and a RAM (Random Access Memory)). Note that the program may be supplied to a computer by being stored on a transitory computer-readable medium of any type. Examples of transitory computer-readable media include electric signals, optical signals, and electromagnetic waves. A transitory computer-readable medium can supply a program to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art. Further, at least one of the functions of the acquisition unit 121, the examination unit 122, and the registration unit 123 described above may be carried out by an information processing device provided and connected to any location on the network, that is, may be carried out by so-called cloud computing.

<Supplementary Notes>

The whole or part of the exemplary embodiments disclosed above can be described as the following supplementary notes. Hereinafter, outlines of the configurations of a service construction supporting method, a service construction supporting device, and a program, according to the present invention, will be described. However, the present invention is not limited to the configurations described below.

### (Supplementary Note 1)

A service construction supporting method for supporting construction of a service using a plurality of resources in combination with each other, the plurality of resources being provided by specific business operators, the method comprising:

acquiring resource information representing information related to the plurality of resources to be used in the service;

on a basis of the resource information of each of the resources to be used in the service, examining feasibility of the service; and

registering the service so as to allow the resources to be used in the service, determined to be feasible, to be provided in combination with each other.

### (Supplementary Note 2)

The service construction supporting method according to supplementary note 1, further comprising:

on a basis of the resource information of the plurality of resources to be used in the service, examining the feasibility of the service by simulating an operation in which the plurality of resources are combined.

### (Supplementary Note 3)

The service construction supporting method according to supplementary note 1 or 2, further comprising:

acquiring condition information representing a provision condition of the service using the plurality of resources in combination with each other; and

on the basis of the resource information of each of the plurality of resources to be used in the service, examining the feasibility of the service using the plurality of resources in combination with each other while satisfying the provision condition represented by the condition information.

### (Supplementary Note 4)

The service construction supporting method according to any of supplementary notes 1 to 3, further comprising:

performing a contract process for use between the business operators providing the plurality of resources to be used in the service determined to be feasible.

### (Supplementary Note 5)

The service construction supporting method according to any of supplementary notes 1 to 4, further comprising:

receiving, from a business operator providing a specific resource, a construction request for a service using the specific resource and another resource provided by another business operator in combination with each other; and

with respect to the construction request for the service, when obtaining a permission from the other business operator providing the other resource, registering the service so as to allow the service using the specific resource and the other resource in combination with each other to be provided.

### (Supplementary Note 6)

The service construction supporting method according to any of supplementary notes 1 to 5, further comprising:

examining feasibility of a new service using a new resource added to the service registered so as to allow the service to be provided by using the plurality of resources in combination with each other, on a basis of resource information of a plurality of resources to be used in the new service, and

registering the new service determined to be feasible so as to allow the plurality of resources, to be used in the new service, to be provided in combination with each other.

### (Supplementary Note 7)

The service construction supporting method according to supplementary note 6, further comprising:

receiving, from a business operator providing a specific resource, a construction request for a new service using the specific resource and a plurality of other resources included in the service registered so as to be allowed to be provided, in combination with each other; and

with respect to the construction request for the new service, when obtaining permission from each of the business operators providing the other resources included in the service registered so as to be allowed to be provided, registering the new service so as to be allowed to be provided, the new service using the specific resource and the plurality of other resources included in the service registered to be provided in combination with each other.

### (Supplementary Note 8)

A service construction supporting device for supporting construction of a service using a plurality of resources in combination with each other, the plurality of resources being provided by specific business operators, the device comprising:

an acquisition unit that acquires resource information representing information related to the plurality of resources to be used in the service;

an examination unit that, on a basis of the resource information of each of the resources to be used in the service, examines feasibility of the service; and

a registration unit that registers the service so as to allow the resources to be used in the service, determined to be feasible, to be provided in combination with each other.

### (Supplementary Note 8.1)

The service construction supporting device according to supplementary note 8, wherein

the examination unit examines the feasibility of the service by simulating an operation in which the plurality of resources are combined, on a basis of the resource information of the plurality of resources to be used in the service.

### (Supplementary Note 8.2)

The service construction supporting device according to supplementary note 8 or 8.1, wherein

the acquisition unit acquires condition information representing a provision condition of the service using the plurality of resources in combination with each other, and

on the basis of the resource information of each of the plurality of resources to be used in the service, the examination unit examines the feasibility of the service using the plurality of resources in combination with each other while satisfying the provision condition represented by the condition information.

### (Supplementary Note 8.3)

The service construction supporting device according to any of supplementary notes 8 to 8.2, wherein

the registration unit performs a contract process for use between the business operators providing the plurality of resources to be used in the service determined to be feasible.

### (Supplementary Note 8.4)

The service construction supporting device according to any of supplementary notes 8 to 8.3, wherein

the acquisition unit receives, from a business operator providing a specific resource, a construction request for a service using the specific resource and another resource provided by another business operator in combination with each other, and

with respect to the construction request for the service, when the registration unit obtains a permission from the other business operator providing the other resource, the registration unit registers the service so as to allow the service using the specific resource and the other resource in combination with each other to be provided.

### (Supplementary Note 8.5)

The service construction supporting device according to any of supplementary notes 8 to 8.4, wherein

the examination unit examines feasibility of a new service using a new resource added to the service registered so as to allow the service to be provided by using the plurality of resources in combination with each other, on a basis of resource information of a plurality of resources to be used in the new service, and

the registration unit registers the new service determined to be feasible so as to allow the plurality of resources, to be used in the new service, to be provided in combination with each other.

### (Supplementary Note 8.6)

The service construction supporting device according to supplementary note 8.5, wherein

the acquisition unit receives, from a business operator providing a specific resource, a construction request for a new service using the specific resource and a plurality of other resources included in the service registered so as to be allowed to be provided, in combination with each other, and

with respect to the construction request for the new service, when the registration unit obtains permission from each of the business operators providing the other resources included in the service registered so as to be allowed to be provided, the registration unit registers the new service so as to be allowed to be provided, the new service using the specific resource and the plurality of other resources included in the service registered to be provided in combination with each other.

### (Supplementary Note 9)

A program for causing an information processing device that supports construction of a service using a plurality of resources in combination with each other, to execute processing to:

acquire resource information representing information related to the plurality of resources to be used in the service;

on the basis of the resource information of each of the resources to be used in the service, examine the feasibility of the service; and

register the service so as to allow the resources to be used in the service, determined to be feasible, to be provided in combination with each other.

### REFERENCE SIGNS LIST

10 service construction supporting device
11 information acquisition unit
12 simulation unit
13 service registration unit
16 resource information storage unit
20 operator terminal
30 service providing device
100 service construction supporting device
101 CPU
102 ROM
103 RAM
104 program group
105 storage device
106 drive
107 communication interface
108 input/output interface
109 bus
110 storage medium
111 communication network
121 acquisition unit
122 examination unit
123 registration unit

1. A service construction supporting method for supporting construction of a service using a plurality of resources in combination with each other, the plurality of resources being provided by specific business operators, the method comprising:
acquiring resource information representing information related to the plurality of resources to be used in the service;
on a basis of the resource information of each of the resources to be used in the service, examining feasibility of the service; and
registering the service so as to allow the resources to be used in the service, determined to be feasible, to be provided in combination with each other.

2. The service construction supporting method according to claim 1, further comprising:
on a basis of the resource information of the plurality of resources to be used in the service, examining the feasibility of the service by simulating an operation in which the plurality of resources are combined.

3. The service construction supporting method according to claim 1, further comprising:
acquiring condition information representing a provision condition of the service using the plurality of resources in combination with each other; and
on the basis of the resource information of each of the plurality of resources to be used in the service, examining the feasibility of the service using the plurality of resources in combination with each other while satisfying the provision condition represented by the condition information.

4. The service construction supporting method according to claim 1, further comprising:
performing a contract process for use between the business operators providing the plurality of resources to be used in the service determined to be feasible.

5. The service construction supporting method according to claim 1, further comprising:
receiving, from a business operator providing a specific resource, a construction request for a service using the specific resource and another resource provided by another business operator in combination with each other; and
with respect to the construction request for the service, when obtaining a permission from the other business operator providing the other resource, registering the service so as to allow the service using the specific resource and the other resource in combination with each other to be provided.

6. The service construction supporting method according to claim 1, further comprising:
examining feasibility of a new service using a new resource added to the service registered so as to allow the service to be provided by using the plurality of resources in combination with each other, on a basis of resource information of a plurality of resources to be used in the new service, and
registering the new service determined to be feasible so as to allow the plurality of resources, to be used in the new service, to be provided in combination with each other.

7. The service construction supporting method according to claim 6, further comprising:
receiving, from a business operator providing a specific resource, a construction request for a new service using the specific resource and a plurality of other resources included in the service registered so as to be allowed to be provided, in combination with each other; and
with respect to the construction request for the new service, when obtaining permission from each of the business operators providing the other resources included in the service registered so as to be allowed to be provided, registering the new service so as to be allowed to be provided, the new service using the specific resource and the plurality of other resources included in the service registered to be provided in combination with each other.

8. A service construction supporting device for supporting construction of a service using a plurality of resources in combination with each other, the plurality of resources being provided by specific business operators, the device comprising:
at least one memory configured to store instructions; and
at least one processor configured to execute instructions to:
acquire resource information representing information related to the plurality of resources to be used in the service;
on a basis of the resource information of each of the resources to be used in the service, examine feasibility of the service; and
register the service so as to allow the resources to be used in the service, determined to be feasible, to be provided in combination with each other.

9. A non-transitory computer-readable medium storing thereon a program comprising instructions for causing an information processing device to execute processing to, the information processing device supporting construction of a service using a plurality of resources in combination with each other:
acquire resource information representing information related to the plurality of resources to be used in the service;
on a basis of the resource information of each of the resources to be used in the service, examine feasibility of the service; and
register the service so as to allow the resources to be used in the service, determined to be feasible, to be provided in combination with each other.
